(19) United States
(12) Patent Application Publication
(10) Pub. No.: US 2017/0246511 A1
(43) Pub. Date: Aug. 31, 2017

(54) GOLF BALL INCORPORATING AT LEAST ONE NON-ISOCYANATE-CONTAINING POLYURETHANE LAYER

(71) Applicant: Acushnet Company, Fairhaven, MA (US)

(72) Inventors: Shawn Ricci, New Bedford, MA (US); John D. Farrell, Providence, RI (US)

(73) Assignee: Acushnet Company, Fairhaven, MA (US)

(21) Appl. No.: 15/054,222

(22) Filed: Feb. 26, 2016

(51) Int. Cl. A63B 37/00; C08G 71/04

(52) U.S. Cl. CPC A63B 37/0058; A63B 37/0075; A63B 37/0078; C08G 71/04

(57) ABSTRACT

A golf ball comprising at least one layer consisting of a non-isocyanate-containing polyurethane composition comprising the reaction product of: at least one amine or polyamine, having an average functionality of 2.0 or greater, and at least one cyclo-carbonate. The amine may be selected for example from the group consisting of: ethylenediamine, hexamethylenediamine, or tris(2-aimnoethyl)amine, or blends thereof; and the polyamine may be selected for example from the group consisting of polyoxypropylene diamines, polyoxypropylene triamines, and combinations thereof. The cyclo-carbonate may comprise for example bis(cyclo-carbonate). Other possible reaction products include: (i) the at least one amine or polyamine and at least one epoxy-cyclo-carbonate oligomer, wherein the non-isocyanate-containing polyurethane composition can be modified with at least one of acrylic or siloxane; or (ii) the at least one amine or polyamine and at least one cyclo-carbonated soybean oil; or (iii) at least one lignin-based polyamine and at least one cyclo-carbonated soybean oil.

### FIELD OF THE INVENTION

Golf balls having at least one layer comprised of a polyurethane composition.

### BACKGROUND OF THE INVENTION

Golf balls are made in a variety of constructions and compositions. In recent years, virtually all golf balls are of a solid construction, generally including a solid core encased by a cover, both of which can have multiple layers, such as a dual core having a solid center and an outer core layer, or a multi-layer cover having an inner and outer cover layer. Examples of golf ball materials range from rubber materials, such as balata, styrene butadiene, polybutadiene, or polyisoprene, to thermoplastic or thermoset resins such as ionomers, polyolefins, polyamides, polyesters, polyurethanes, polyureas and/or polyurethane/polyurea hybrids. Typically, outer layers are formed about the spherical outer surface of an innermost golf ball layer via compression molding, casting, or injection molding.

Golf ball manufacturers constantly explore and consider new materials that can efficiently and cost effectively target and improve aerodynamic and/or inertial properties without sacrificing desired feel and durability. For example, thermoset, castable polyurethanes became popular for making golf ball covers. Polyurethane compositions contain urethane linkages formed by reacting an isocyanate group (—N═C═O) with a hydroxyl group (OH). Polyurethanes are produced by the reaction of a multi-functional isocyanate with a polyol in the presence of a catalyst and other additives. The chain length of the polyurethane prepolymer is extended by reacting it with a hydroxyl-terminated curing agent.

Isocyanates with two or more functional groups are used in producing polyurethane polymers. Manufacturers often use aromatic isocyanates for several reasons including their high reactivity and costs benefits. It normally is more economically advantageous to use aromatic isocyanates over other isocyanate compounds, because the raw material costs for aromatic isocyanates are generally lower. Furthermore, the aromatic isocyanates are able to react with the hydroxyl or amine compounds and form a durable and tough polymer having a high melting point. The resulting polyurethane generally has good mechanical strength and cut/shear-resistance.

However, one disadvantage with using aromatic isocyanates is the polymeric reaction product tends to have poor light stability and may discolor upon exposure to light, particularly ultraviolet (UV) light. Because aromatic isocyanates are used as a reactant, some aromatic structures may be found in the reaction product. Such aromatic structures are inherently unstable and the resulting material tends to discolor when exposed over long time periods to UV light rays. Hence, UV light stabilizers are commonly added to the formulation, but the covers may still develop a yellowish appearance over prolonged exposure to sunlight. Consequently, such covers are normally painted with a white paint and then covered with a transparent coating to protect the ball's appearance.

In an attempt to overcome the yellowing problems encountered with aromatic isocyanates, aliphatic isocyanates were used to form the prepolymer instead. Examples of aliphatic isocyanates include, but are not limited to, isophorone diisocyanate (IPDI), 1,6-hexamethylene diisocyanate (HDI), 4,4′-dicyclohexylmethane diisocyanate (“H₁₂ MDI”), and homopolymers and copolymers thereof. These aliphatic isocyanates provided polyurethane and polyurea polymers having good light stability. However, such polymers tend to have reduced mechanical strength and cut/shear-resistance.

Accordingly, one approach sought to overcome the drawbacks of aliphatic isocyanate-based polyurethanes and aromatic-based polyurethanes isocyanates by essentially splitting the cover into two separate and distinct layers—an inner cover layer formed from the more durable aromatic polyurethane, and an outer cover layer containing the more color stable aliphatic polyurethane. See co-owned U.S. Pat. No. 9,044,648 of Sullivan et al. In such golf balls, the polyurethane material of each layer contributes separately to achieve a unique combination of physical, playing, cosmetic, and color-stable golf ball properties.

Nevertheless, several drawbacks remain with incorporating conventional polyurethane materials in golf balls. First, water/moisture in the surrounding air or in the substrate itself can undesirably react with free isocyanate groups if the reaction is not isolated from water, thereby yielding a hardened, unusable material. Additionally, hydrolytically unstable chemical bonds in the resulting polymer structure can make the resulting layer vulnerable to environmental degradation. Moreover, these isocyanates are highly toxic and result from an even more toxic predecessor, phosgene, which is known to present substantial safety/environmental hazards/risks.

Accordingly, there is still a need for golf balls which incorporate materials that have possess/display the benefits of conventional isocyanate-containing aromatic and/or aliphatic polyurethanes but without the aforementioned problems associated therewith. The golf ball of the invention addresses and solves these needs.

### SUMMARY OF THE INVENTION

Accordingly, a golf ball of the invention comprises at least one layer consisting of a non-isocyanate-containing polyurethane composition comprising the reaction product of at least one amine or polyamine having an average functionality of 2.0 or greater, and at least one cyclo-carbonate. The at least one cyclo-carbonate may comprise bis(cyclo-carbonate). The at least one amine may be selected from the group consisting of: ethylenediamine, hexamethylenediamine, or tris(2-aimnoethyl)amine, or blends thereof. The at least one polyamine may be selected from the group consisting of polyoxypropylene diamines, polyoxypropylene triamines, and combinations thereof.

In one embodiment, the at least one layer may be a core layer. In another embodiment, the at least one layer may be an intermediate layer disposed about a thermoset core. In yet another embodiment, the at least one layer may be a cover layer such as an inner cover layer and/or an outer cover layer. In still another embodiment, the at least one layer may be a coating layer that is formed about an outermost cover layer of the golf ball.

Advantageously, the at least one layer may also be a tie layer that is disposed between and adjacent to two golf ball layers that differ and do not comprise the non-isocyanate-containing polyurethane composition.

The non-isocyanate-containing polyurethane composition may further comprise density-adjusting fillers, process aides, plasticizers, blowing or foaming agents, fillers such as metal powder, metal alloy powder, metal oxide, metal stearates, particulates, flakes, fibers, carbonaceous material, or combinations thereof.

In another embodiment, a golf ball of the invention comprises at least one layer consisting of a non-isocyanate-containing polyurethane composition comprising the reaction product of at least one amine or polyamine, having an average functionality of 2.0 or greater, and at least one epoxy-cyclo-carbonate oligomer.

The non-isocyanate-containing polyurethane composition may be modified with at least one of acrylic or siloxane. Modification with acrylic imparts light stability to the resulting non-isocyanate-containing polyurethane composition, and siloxane can strengthen adhesion and mechanical properties of the non-isocyanate-containing polyurethane composition.

In yet another embodiment, a golf ball of the invention comprises at least one layer consisting of a non-isocyanate-containing polyurethane composition comprising the reaction product of at least one amine or polyamine having an average functionality of 2.0 or greater, and at least one cyclo-carbonated soybean oil.

And in a different embodiment, a golf ball of the invention comprises at least one layer consisting of a non-isocyanate-containing polyurethane composition comprising the reaction product of at least one lignin-based polyamine and at least one cyclo-carbonated soybean oil.

In one embodiment, a finished golf ball of the invention may have a coefficient of restitution (COR) of about 0.790 or greater.

In one particular embodiment, a golf ball of the invention may comprise a first layer consisting of a non-isocyanate-containing polyurethane composition comprising the reaction product of at least one amine or polyamine having an average functionality of 2.0 or greater, and at least one cyclo-carbonate; wherein the first layer is disposed between and adjacent to a second inner layer and third outer layer, each which do not contain the non-isocyanate-containing polyurethane composition of the first layer; wherein the first layer has a first coefficient of restitution that is less than a second coefficient of restitution of the second inner layer and less than a third coefficient of restitution of the third outer layer; and wherein the golf ball as a whole has a ball coefficient of restitution that is greater than the first coefficient of restitution and less than at least one of the second coefficient of restitution and the third coefficient of restitution.

In another particular embodiment, a golf ball of the invention may comprise a first layer consisting of a non-isocyanate-containing polyurethane composition comprising the reaction product of at least one amine or polyamine having an average functionality of 2.0 or greater, and at least one cyclo-carbonate; wherein the first layer is adjacent to a second layer that does not contain the non-isocyanate-containing polyurethane composition of the first layer; wherein the first layer has a first coefficient of restitution that is less than a second coefficient of restitution of the second layer; and wherein the golf ball as a whole has a ball coefficient of restitution that is greater than the first coefficient of restitution.

The invention is also directed to a method of making a golf ball of the invention, comprising providing at least one layer consisting of a non-isocyanate-containing polyurethane composition that is formed by the steps comprising reacting at least one amine or polyamine having an average functionality of 2.0 or greater with at least one cyclo-carbonate.

### DETAILED DESCRIPTION

A golf ball of the invention advantageously incorporates at least one layer consisting of a non-isocyanate polyurethane composition (NIPU) having the mechanical strength and cut/shear-resistance of conventional isocyanate-containing aromatic polyurethanes and the light stability of isocyanate-containing aliphatic polyurethanes, but without their respective drawbacks. Such layers can beneficially replace a conventional polyurethane elastomer system without using highly toxic isocyanates and their precursors, and meanwhile displaying increased chemical resistance, lower permeability, and thermal stability. Meanwhile, incorporating a non-isocyanate based polyurethane composition desirably eliminates the need to isolate water/moisture in the surrounding air or in the substrate itself during formation of the composition.

The mechanism forming at least one golf ball layer consisting of a non-isocyanate polyurethane composition is totally different than that for forming conventional isocyanate-containing polyurethanes. In a golf ball of the invention, a linear non-isocyanate polyurethane generally may be formed via reaction of diamines and cyclo-carbonates such as bis(cyclo-carbonates). Cyclo-carbonates are desirable due to their high solvency and high boiling points, as well as their biodegradability and low toxicity.

Cyclo-carbonates exhibit wide reactivities with aliphatic and aromatic amines, alcohols, thiols, and carboxylic acids. One example of a linear NIPU preparation is the reaction of erythritol dicarbonate and unhindered primary aliphatic diamines in dimethylformamide at room temperature.

Amines can include for example ethylenediamine, hexamethylenediamine, and tris(2-aimnoethyl)amines. Polyamines such as polyoxypropylene diamines and polyoxypropylene triamines may also be utilized. Amine functionality should be equal to or greater than 2.0 to form repeating urethane chain linkages.

Additionally, hybrid non-isocyanate-containing polyurethane networks can be formed by the reaction of epoxy/cyclo-carbonate oligomers with amines. The NIPU network can be completed in a multistep process. First, insertion of CO2 into epoxy moeity can yield cyclo-carbonate oligomer. Then, this oligomer may be end-capped by diamine reactants with different reactivity. Finally, the remaining amine groups in the oligomer may react with epoxy resin to form a cross-linked structure.

Additionally, renewable resources can be used in the formation of NIPU. For example, cyclo-carbonated soybean oil (obtained via reaction of epoxidized soybean oil with CO2) is one such renewable resource that may be used in the NIPU reaction.

And traditional two-part casting methods for urethane materials may be used to produce golf balls of the invention incorporating a NIPU layer.

An introduction to some non-isocyanate-based polyurethane materials, or NIPU's, may be found, for example, in Guan et al., Progress in Study of Non-Isocyanate Polyurethane, Ind. Eng. Chem. Res., pp. 6517-6527 (2011); O. Figovsky et al., Progress in Elaboration of Nonisocyanate Polyurethanes Based on Cyclic Carbonates, International Letters of Chemistry, Physics and Astronomy, pp. 52-66 (2012); O. Figovsky et al., Recent Advances In the Development of Non-isocyanate Polyurethanes Based on Cyclic Carbonates, PU Magazine, Vol. 10m No. 4, August/September 2013; and Albert Lee, Synthesis of Polyurethane From One Hundred Percent Sustainable Natural Materials Through Non-Isocyanate Reactions, Thesis, Georgia Institute of Technology, December, 2014, the entire disclosures of which are hereby incorporated herein by reference in their entireties.

Golf balls of the invention may comprise a core, a cover and, optionally, at least one intermediate layer disposed concentrically adjacent to the core between the core and the cover. The core may be single or a multi-layered and the cover may also comprise one or more layers. At least one of portion of the golf ball, i.e., core, cover, optional intermediate layer, coating layer and/or a tie-layer consists of the non-isocyanate-containing polyurethane composition.

For example, in one golf ball construction, a golf ball of the invention may comprise a single layer core and a single layer cover, wherein the core comprises a thermoset or thermoplastic composition, and the cover consists of a non-isocyanate-containing polyurethane composition. In one such embodiment, the non-isocyanate-containing polyurethane composition comprises the reaction product of at least one amine or polyamine having an average functionality of 2.0 or greater, and at least one cyclo-carbonate. In another embodiment, the non-isocyanate-containing polyurethane composition comprises the reaction product of at least one amine or polyamine, having an average functionality of 2.0 or greater, and at least one epoxy-cyclo-carbonate oligomer. In yet another embodiment, the non-isocyanate-containing polyurethane composition comprises the reaction product of at least one amine or polyamine having an average functionality of 2.0 or greater, and at least one cyclo-carbonated soybean oil. In still another embodiment, the non-isocyanate-containing polyurethane composition comprises the reaction product of at least one lignin-based polyamine and at least one cyclo-carbonated soybean oil.

In another golf ball construction, a golf ball of the invention may comprise a dual core comprising an inner core layer and an outer core layer, wherein each core layer comprises a different thermoset or thermoplastic composition. In this embodiment, the dual core is surrounded by a dual cover, wherein an inner cover layer is formed from an ionomeric material and the outer cover layer consists of the non-isocyanate-containing polyurethane composition. In one embodiment, the non-isocyanate-containing polyurethane composition comprises the reaction product of at least one amine or polyamine having an average functionality of 2.0 or greater, and at least one cyclo-carbonate. In another embodiment, the non-isocyanate-containing polyurethane composition comprises the reaction product of at least one amine or polyamine, having an average functionality of 2.0 or greater, and at least one epoxy-cyclo-carbonate oligomer. In yet another embodiment, the non-isocyanate-containing polyurethane composition comprises the reaction product of at least one amine or polyamine having an average NCO functionality of 2.0 or greater, and at least one cyclo-carbonated soybean oil. In still another embodiment, the non-isocyanate-containing polyurethane composition comprises the reaction product of at least one lignin-based polyamine and at least one cyclo-carbonated soybean oil.

In yet another golf ball construction, a golf ball of the invention may comprise a core comprising a thermoset rubber composition, surrounded by a casing layer that consists of the non-isocyanate-containing polyurethane composition, which is surrounded by an ionomeric inner cover layer, with an outer cover layer being disposed about the inner cover layer that consists of the non-isocyanate-containing polyurethane composition.

In still another golf ball construction, a golf ball of the invention may comprise a core, an intermediate layer, a cover, and a tie layer that is disposed between the intermediate layer and the cover. In this embodiment, the core comprises a polybutadiene rubber composition, the intermediate layer comprises an ionomeric composition, the cover comprises a conventional polyurethane composition, and the tie layer consists of the non-isocyanate-containing polyurethane composition. In one embodiment, the non-isocyanate-containing polyurethane composition comprises the reaction product of at least one amine or polyamine having an average functionality of 2.0 or greater, and at least one cyclo-carbonate. In another embodiment, the non-isocyanate-containing polyurethane composition comprises the reaction product of at least one amine or polyamine, having an average functionality of 2.0 or greater, and at least one epoxy-cyclo-carbonate oligomer. In yet another embodiment, the non-isocyanate-containing polyurethane composition comprises the reaction product of at least one amine or polyamine having an average functionality of 2.0 or greater, and at least one cyclo-carbonated soybean oil. In still another embodiment, the non-isocyanate-containing polyurethane composition comprises the reaction product of at least one lignin-based polyamine and at least one cyclo-carbonated soybean oil.

In a different embodiment, a golf ball of the invention may comprise a single layer core and a single layer cover, wherein the core comprises a thermoset or thermoplastic composition, and both the cover and a coating layer disposed about the cover consist of a non-isocyanate-containing polyurethane composition. In one particular embodiment, the cover and coating layer may each consist of the same or of a substantially similar non-isocyanate-containing polyurethane composition. In another particular embodiment, the cover and coating layer may each consist of different non-isocyanate-containing polyurethane compositions. That is, at least one of the following may be incorporated in the cover and/or coating layer: (i) the non-isocyanate-containing polyurethane composition may comprise the reaction product of at least one amine or polyamine having an average functionality of 2.0 or greater, and at least one cyclo-carbonate; (ii) the non-isocyanate-containing polyurethane composition may comprise the reaction product of at least one amine or polyamine, having an average functionality of 2.0 or greater, and at least one epoxy-cyclo-carbonate oligomer; (iii) the non-isocyanate-containing polyurethane composition may comprise the reaction product of at least one amine or polyamine having an average functionality of 2.0 or greater, and at least one cyclo-carbonated soybean oil; the non-isocyanate-containing polyurethane composition may comprise the reaction product of at least one lignin-based polyamine and at least one cyclo-carbonated soybean oil.

Meanwhile, in a golf ball of the invention, an overall golf ball coefficient of restitution (CoR) may be targeted by coordinating the CoRs of each layer. And it is envisioned that a golf ball of the invention may be formulated and constructed to have any desired overall golf ball CoR.

The CoR is a measure of the resilience of a golf ball. A relatively high golf ball CoR allows the golf ball to reach high velocity when struck by a golf club. Thus, the ball tends to travel a greater distance which is particularly important for driver shots off the tee. At the same time, it is often desirable that a golf ball exhibit a soft and comfortable feel. Players can then experience a better sense of control and natural feeling when making the shot. In this regard, the coefficient of restitution or CoR of a golf ball or golf ball subassembly (for example, a golf ball core) is the ratio of the relative velocity of an elastic sphere after direct impact to that before impact. CoR can therefore vary from 0 to 1, with 1 being equivalent to a perfectly or completely elastic collision and 0 being equivalent to a perfectly or completely inelastic collision. The CoR is determined according to a known procedure, wherein the golf ball or golf ball subassembly is fired from an air cannon at two given velocities and a velocity of 125 ft/s is used for the calculations. Ballistic light screens are located between the air cannon and steel plate at a fixed distance to measure ball velocity. As the ball travels toward the steel plate, it activates each light screen and the ball's time period at each light screen is measured. This provides an incoming transit time period which is inversely proportional to the ball's incoming velocity. The ball makes impact with the steel plate and rebounds so it passes again through the light screens. As the rebounding ball activates each light screen, the ball's time period at each screen is measured. This provides an outgoing transit time period which is inversely proportional to the ball's outgoing velocity. The CoR is then calculated as the ratio of the ball's outgoing transit time period to the ball's incoming transit time period (CoR=Vₒᵤₜ/Vᵢₙ=Tᵢₙ/Tₒᵤₜ).

Thus, some examples of how the CoR of the layer consisting of a non-isocyanate-containing polyurethane composition may be coordinated with the CoR of other layers of the golf ball are as follows. In one embodiment, a golf ball of the invention comprises a first layer consisting of a non-isocyanate-containing polyurethane composition comprising the reaction product of at least one amine or polyamine having an average functionality of 2.0 or greater, and at least one cyclo-carbonate. The first layer is disposed between and adjacent to a second inner layer and third outer layer, each of which do not contain the non-isocyanate-containing polyurethane composition of the first layer. The first layer has a first coefficient of restitution that is less than a second coefficient of restitution of the second inner layer and less than a third coefficient of restitution of the third outer layer. And the golf ball as a whole has a ball coefficient of restitution that is greater than the first coefficient of restitution and less than at least one of the second coefficient of restitution and the third coefficient of restitution.

Embodiments are also envisioned wherein the first coefficient of restitution is greater than at least one of the second coefficient of restitution or the third coefficient of restitution, and the ball coefficient of restitution is greater than at least one of the first coefficient of restitution, second coefficient of restitution, or the third coefficient of restitution.

Alternatively, a golf ball of the invention may comprise a first layer consisting of a non-isocyanate-containing polyurethane composition comprising the reaction product of at least one amine or polyamine having an average functionality of 2.0 or greater, and at least one cyclo-carbonate; and the first layer is adjacent to a second layer that does not contain the non-isocyanate-containing polyurethane composition of the first layer. The first layer has a first coefficient of restitution that is less than a second coefficient of restitution of the second layer; and the golf ball as a whole has a ball coefficient of restitution that is greater than the first coefficient of restitution.

Embodiments are also envisioned wherein the first coefficient of restitution is greater than the second coefficient of restitution and the ball coefficient of restitution that is less than at least one of the first coefficient of restitution or second coefficient of restitution.

A golf ball of the invention may otherwise be constructed of any known number of other layers formed from conventional golf ball materials and having any known diameter and/or thickness, hardness, compression and/or other golf ball properties, which, when coordinated with the at least one layer consisting of a non-isocyanate-containing polyurethane composition, may target particular desired playing characteristics.

For example, in one particular embodiment of a golf ball of the invention, the innermost golf ball layer of a golf ball of the invention may be a rubber-containing inner core, wherein the base rubber may be selected from polybutadiene rubber, polyisoprene rubber, natural rubber, ethylene-propylene rubber, ethylene-propylene diene rubber, styrene-butadiene rubber, and combinations of two or more thereof. A preferred base rubber is polybutadiene. Another preferred base rubber is polybutadiene optionally mixed with one or more elastomers selected from polyisoprene rubber, natural rubber, ethylene propylene rubber, ethylene propylene diene rubber, styrene-butadiene rubber, polystyrene elastomers, polyethylene elastomers, polyurethane elastomers, polyurea elastomers, metallocene-catalyzed elastomers, and plastomers.

Suitable curing processes include, for example, peroxide curing, sulfur curing, radiation, and combinations thereof. In one embodiment, the base rubber is peroxide cured. Organic peroxides suitable as free-radical initiators include, for example, dicumyl peroxide; n-butyl-4,4-di(t-butylperoxy) valerate; 1,1-di(t-butylperoxy)3,3,5-trimethylcyclohexane; 2,5-dimethyl-2,5-di(t-butylperoxy) hexane; di-t-butyl peroxide; di-t-amyl peroxide; t-butyl peroxide; t-butyl cumyl peroxide; 2,5-dimethyl-2,5-di(t-butylperoxy)hexyne-3; di(2-t-butyl-peroxyisopropyl)benzene; dilauroyl peroxide; dibenzoyl peroxide; t-butyl hydroperoxide; and combinations thereof. Peroxide free-radical initiators are generally present in the rubber compositions in an amount within the range of 0.05 to 15 parts, preferably 0.1 to 10 parts, and more preferably 0.25 to 6 parts by weight per 100 parts of the base rubber. Cross-linking agents are used to cross-link at least a portion of the polymer chains in the composition. Suitable cross-linking agents include, for example, metal salts of unsaturated carboxylic acids having from 3 to 8 carbon atoms; unsaturated vinyl compounds and polyfunctional monomers (e.g., trimethylolpropane trimethacrylate); phenylene bismaleimide; and combinations thereof. Particularly suitable metal salts include, for example, one or more metal salts of acrylates, diacrylates, methacrylates, and dimethacrylates, wherein the metal is selected from magnesium, calcium, zinc, aluminum, lithium, and nickel. In a particular embodiment, the cross-linking agent is selected from zinc salts of acrylates, diacrylates, methacrylates, and dimethacrylates. When the cross-linking agent is zinc diacrylate and/or zinc dimethacrylate, the agent typically is included in the rubber composition in an amount within the range of 1 to 60 parts, preferably 5 to 50 parts, and more preferably 10 to 40 parts, by weight per 100 parts of the base rubber.

In a preferred embodiment, the cross-linking agent used in the rubber composition of the core and epoxy composition of the intermediate layer and/or cover layer is zinc diacrylate (“ZDA”). Adding the ZDA curing agent to the rubber composition makes the core harder and improves the resiliency/CoR of the ball. Adding the same ZDA curing agent epoxy composition makes the intermediate and cover layers harder and more rigid. As a result, the overall durability, toughness, and impact strength of the ball is improved.

Sulfur and sulfur-based curing agents with optional accelerators may be used in combination with or in replacement of the peroxide initiators to cross-link the base rubber. High energy radiation sources capable of generating free-radicals may also be used to cross-link the base rubber. Suitable examples of such radiation sources include, for example, electron beams, ultra-violet radiation, gamma radiation, X-ray radiation, infrared radiation, heat, and combinations thereof.

The rubber compositions may also contain “soft and fast” agents such as a halogenated organosulfur, organic disulfide, or inorganic disulfide compound. Particularly suitable halogenated organosulfur compounds include, but are not limited to, halogenated thiophenols. Preferred organic sulfur compounds include, but not limited to, pentachlorothiophenol (“PCTP”) and a salt of PCTP. A preferred salt of PCTP is ZnPCTP. A suitable PCTP is sold by the Struktol Company (Stow, Ohio) under the tradename, A95. ZnPCTP is commercially available from EchinaChem (San Francisco, Calif.). These compounds also may function as cis-to-trans catalysts to convert some cis-1,4 bonds in the polybutadiene to trans-1,4 bonds. Peroxide free-radical initiators are generally present in the rubber compositions in an amount within the range of 0.05 to 10 parts and preferably 0.1 to 5 parts. Antioxidants also may be added to the rubber compositions to prevent the breakdown of the elastomers. Other ingredients such as accelerators (for example, tetra methylthiuram), processing aids, processing oils, dyes and pigments, wetting agents, surfactants, plasticizers, as well as other additives known in the art may be added to the composition. Generally, the fillers and other additives are present in the rubber composition in an amount within the range of 1 to 70 parts by weight per 100 parts of the base rubber. The core may be formed by mixing and forming the rubber composition using conventional techniques. Of course, embodiments are also envisioned wherein outer layers comprise such rubber-based compositions

However, core layers, intermediate/casing layers, and cover layers may additionally or alternatively be formed from other materials such as an ionomeric material including ionomeric polymers, preferably highly-neutralized ionomers (HNP). In another embodiment, the intermediate layer of the golf ball is formed from an HNP material or a blend of HNP materials. The acid moieties of the HNP's, typically ethylene-based ionomers, are preferably neutralized greater than about 70%, more preferably greater than about 90%, and most preferably at least about 100%. The HNP's can be also be blended with a second polymer component, which, if containing an acid group, may also be neutralized. The second polymer component, which may be partially or fully neutralized, preferably comprises ionomeric copolymers and terpolymers, ionomer precursors, thermoplastics, polyamides, polycarbonates, polyesters, polyurethanes, polyureas, polyurethane/urea hybrids, thermoplastic elastomers, polybutadiene rubber, balata, metallocene-catalyzed polymers (grafted and non-grafted), single-site polymers, high-crystalline acid polymers, cationic ionomers, and the like. HNP polymers typically have a material hardness of between about 20 and about 80 Shore D, and a flexural modulus of between about 3,000 psi and about 200,000 psi.

Non-limiting examples of suitable ionomers include partially neutralized ionomers, blends of two or more partially neutralized ionomers, highly neutralized ionomers, blends of two or more highly neutralized ionomers, and blends of one or more partially neutralized ionomers with one or more highly neutralized ionomers. Methods of preparing ionomers are well known, and are disclosed, for example, in U.S. Pat. No. 3,264,272, the entire disclosure of which is hereby incorporated herein by reference. The acid copolymer can be a direct copolymer wherein the polymer is polymerized by adding all monomers simultaneously, as disclosed, for example, in U.S. Pat. No. 4,351,931, the entire disclosure of which is hereby incorporated herein by reference. Alternatively, the acid copolymer can be a graft copolymer wherein a monomer is grafted onto an existing polymer, as disclosed, for example, in U.S. Patent Application Publication No. 2002/0013413, the entire disclosure of which is hereby incorporated herein by reference.

Examples of suitable partially neutralized acid polymers include, but are not limited to, Surlyn® ionomers, commercially available from E. I. du Pont de Nemours and Company; AClyn® ionomers, commercially available from Honeywell International Inc.; and Iotek® ionomers, commercially available from Exxon Mobil Chemical Company. Some suitable examples of highly neutralized ionomers (HNP) are DuPont® HPF 1000 and DuPont® HPF 2000, ionomeric materials commercially available from E. I. du Pont de Nemours and Company. In some embodiments, very low modulus ionomer- (“VLMI-”) type ethylene-acid polymers are particularly suitable for forming the HNP, such as Surlyn® 6320, Surlyn® 8120, Surlyn® 8320, and Surlyn® 9320, commercially available from E. I. du Pont de Nemours and Company.

It is meanwhile envisioned that in some embodiments/golf ball constructions, it may be beneficial to also include at least one layer formed from or blended with a conventional isocyante-based material. The following conventional compositions as known in the art may be incorporated to achieve particular desired golf ball characteristics:

(1) Polyurethanes, such as those prepared from polyols and diisocyanates or polyisocyanates and/or their prepolymers, and those disclosed in U.S. Pat. Nos. 5,334,673 and 6,506,851;

(2) Polyureas, such as those disclosed in U.S. Pat. Nos. 5,484,870 and 6,835,794; and

(3) Polyurethane/urea hybrids, blends or copolymers comprising urethane and urea segments such as those disclosed in U.S. Pat. No. 8,506,424.

Suitable polyurethane compositions comprise a reaction product of at least one polyisocyanate and at least one curing agent. The curing agent can include, for example, one or more polyols. The polyisocyanate can be combined with one or more polyols to form a prepolymer, which is then combined with the at least one curing agent. Thus, the polyols described herein are suitable for use in one or both components of the polyurethane material, i.e., as part of a prepolymer and in the curing agent. Suitable polyurethanes are described in U.S. Pat. No. 7,331,878, which is incorporated herein in its entirety by reference.

In general, polyurea compositions contain urea linkages formed by reacting an isocyanate group (—N═C═O) with an amine group (NH or NH₂). The chain length of the polyurea prepolymer is extended by reacting the prepolymer with an amine curing agent. The resulting polyurea has elastomeric properties, because of its “hard” and “soft” segments, which are covalently bonded together. The soft, amorphous, low-melting point segments, which are formed from the polyamines, are relatively flexible and mobile, while the hard, high-melting point segments, which are formed from the isocyanate and chain extenders, are relatively stiff and immobile. The phase separation of the hard and soft segments provides the polyurea with its elastomeric resiliency. The polyurea composition contains urea linkages having the following general structure:

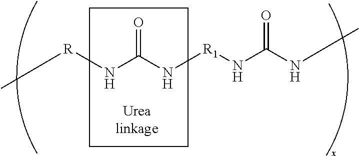

where x is the chain length, i.e., about 1 or greater, and R and R₁ are straight chain or branched hydrocarbon chains having about 1 to about 20 carbon atoms.

A polyurea/polyurethane hybrid composition is produced when the polyurea prepolymer (as described above) is chain-extended using a hydroxyl-terminated curing agent. Any excess isocyanate groups in the prepolymer will react with the hydroxyl groups in the curing agent and create urethane linkages. That is, a polyurea/polyurethane hybrid composition is produced.

In a preferred embodiment, a pure polyurea composition, as described above, is prepared. That is, the composition contains only urea linkages. An amine-terminated curing agent is used in the reaction to produce the pure polyurea composition. However, it should be understood that a polyurea/polyurethane hybrid composition also may be prepared in accordance with this invention as discussed above. Such a hybrid composition can be formed if the polyurea prepolymer is cured with a hydroxyl-terminated curing agent. Any excess isocyanate in the polyurea prepolymer reacts with the hydroxyl groups in the curing agent and forms urethane linkages. The resulting polyurea/polyurethane hybrid composition contains both urea and urethane linkages. The general structure of a urethane linkage is shown below:

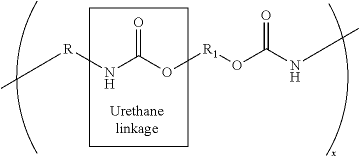

where x is the chain length, i.e., about 1 or greater, and R and R₁ are straight chain or branched hydrocarbon chains having about 1 to about 20 carbon atoms.

There are two basic techniques that can be used to make the polyurea and polyurea/urethane compositions of this invention: a) one-shot technique, and b) prepolymer technique. In the one-shot technique, the isocyanate blend, polyamine, and hydroxyl and/or amine-terminated curing agent are reacted in one step. On the other hand, the prepolymer technique involves a first reaction between the isocyanate blend and polyamine to produce a polyurea prepolymer, and a subsequent reaction between the prepolymer and hydroxyl and/or amine-terminated curing agent. As a result of the reaction between the isocyanate and polyamine compounds, there will be some unreacted NCO groups in the polyurea prepolymer. The prepolymer should have less than 14% unreacted NCO groups. Preferably, the prepolymer has no greater than 8.5% unreacted NCO groups, more preferably from 2.5% to 8%, and most preferably from 5.0% to 8.0% unreacted NCO groups. As the weight percent of unreacted isocyanate groups increases, the hardness of the composition also generally increases.

Either the one-shot or prepolymer method may be employed to produce the polyurea and polyurea/urethane compositions of the invention; however, the prepolymer technique is preferred because it provides better control of the chemical reaction. The prepolymer method provides a more homogeneous mixture resulting in a more consistent polymer composition. The one-shot method results in a mixture that is inhomogeneous (more random) and affords the manufacturer less control over the molecular structure of the resultant composition.

In the casting process, the polyurea and polyurea/urethane compositions can be formed by chain-extending the polyurea prepolymer with a single curing agent or blend of curing agents as described further below. The compositions of the present invention may be selected from among both castable thermoplastic and thermoset materials. Thermoplastic polyurea compositions are typically formed by reacting the isocyanate blend and polyamines at a 1:1 stoichiometric ratio. Thermoset compositions, on the other hand, are cross-linked polymers and are typically produced from the reaction of the isocyanate blend and polyamines at normally a 1.05:1 stoichiometric ratio. In general, thermoset polyurea compositions are easier to prepare than thermoplastic polyureas.

The polyurea prepolymer can be chain-extended by reacting it with a single curing agent or blend of curing agents (chain-extenders). In general, the prepolymer can be reacted with hydroxyl-terminated curing agents, amine-terminated curing agents, or mixtures thereof. The curing agents extend the chain length of the prepolymer and build-up its molecular weight. Normally, the prepolymer and curing agent are mixed so the isocyanate groups and hydroxyl or amine groups are mixed at a 1.05:1.00 stoichiometric ratio.

A catalyst may be employed to promote the reaction between the isocyanate and polyamine compounds for producing the prepolymer or between prepolymer and curing agent during the chain-extending step. Preferably, the catalyst is added to the reactants before producing the prepolymer. Suitable catalysts include, but are not limited to, bismuth catalyst; zinc octoate; stannous octoate; tin catalysts such as bis-butyltin dilaurate, bis-butyltin diacetate, stannous octoate; tin (II) chloride, tin (IV) chloride, bis-butyltin dimethoxide, dimethyl-bis[1-oxonedecyl)oxy]stannane, di-n-octyltin bis-isooctyl mercaptoacetate; amine catalysts such as triethylenediamine, triethylamine, and tributylamine; organic acids such as oleic acid and acetic acid; delayed catalysts; and mixtures thereof. The catalyst is preferably added in an amount sufficient to catalyze the reaction of the components in the reactive mixture. In one embodiment, the catalyst is present in an amount from about 0.001 percent to about 1 percent, and preferably 0.1 to 0.5 percent, by weight of the composition.

The hydroxyl chain-extending (curing) agents are preferably selected from the group consisting of ethylene glycol; diethylene glycol; polyethylene glycol; propylene glycol; 2-methyl-1,3-propanediol; 2-methyl-1,4-butanediol; monoethanolamine; diethanolamine; triethanolamine; monoisopropanolamine; diisopropanolamine; dipropylene glycol; polypropylene glycol; 1,2-butanediol; 1,3-butanediol; 1,4-butanediol; 2,3-butanediol; 2,3-dimethyl-2,3-butanediol; trimethylolpropane; cyclohexyldimethylol; triisopropanolamine; N,N,N′,N′-tetra-(2-hydroxypropyl)-ethylene diamine; diethylene glycol bis-(aminopropyl) ether; 1,5-pentanediol; 1,6-hexanediol; 1,3-bis-(2-hydroxyethoxy) cyclohexane; 1,4-cyclohexyldimethylol; 1,3-bis-[2-(2-hydroxyethoxy) ethoxy]cyclohexane; 1,3-bis-{2-[2-(2-hydroxyethoxy) ethoxy]ethoxy}cyclohexane; trimethylolpropane; polytetramethylene ether glycol (PTMEG), preferably having a molecular weight from about 250 to about 3900; and mixtures thereof.

Suitable amine chain-extending (curing) agents that can be used in chain-extending the polyurea prepolymer of this invention include, but are not limited to, unsaturated diamines such as 4,4′-diamino-diphenylmethane (i.e., 4,4′-methylene-dianiline or “MDA”), m-phenylenediamine, p-phenylenediamine, 1,2- or 1,4-bis(sec-butylamino)benzene, 3,5-diethyl-(2,4- or 2,6-)toluenediamine or “DETDA”, 3,5-dimethylthio-(2,4- or 2,6-)toluenediamine, 3,5-diethylthio-(2,4- or 2,6-)toluenediamine, 3,3′-dimethyl-4,4′-diamino-diphenylmethane, 3,3′-diethyl-5,5′-dimethyl4,4′-diamino-diphenylmethane (i.e., 4,4′-methylene-bis(2-ethyl-6-methyl-benezeneamine)), 3,3′-dichloro-4,4′-diamino-diphenylmethane (i.e., 4,4′-methylene-bis(2-chloroaniline) or “MOCA”), 3,3′,5,5′-tetraethyl-4,4′-diamino-diphenylmethane (i.e., 4,4′-methylene-bis(2,6-diethylaniline), 2,2′-dichloro-3,3′,5,5′-tetraethyl-4,4′-diamino-diphenylmethane (i.e., 4,4′-methylene-bis(3-chloro-2,6-diethyleneaniline) or “MCDEA”), 3,3′-diethyl-5,5′-dichloro-4,4′-diamino-diphenylmethane, or “MDEA”), 3,3′-dichloro-2,2′,6,6′-tetraethyl-4,4′-diamino-diphenylmethane, 3,3′-dichloro-4,4′-diamino-diphenylmethane, 4,4′-methylene-bis(2,3-dichloroaniline) (i.e., 2,2′,3,3′-tetrachloro-4,4′-diamino-diphenylmethane or “MDCA”), 4,4′-bis(sec-butylamino)-diphenylmethane, N,N′-dialkylamino-diphenylmethane, trimethyleneglycol-di(p-aminobenzoate), polyethyleneglycol-di(p-aminobenzoate), polytetramethyleneglycol-di(p-aminobenzoate); saturated diamines such as ethylene diamine, 1,3-propylene diamine, 2-methyl-pentamethylene diamine, hexamethylene diamine, 2,2,4- and 2,4,4-trimethyl-1,6-hexane diamine, imino-bis(propylamine), imido-bis(propylamine), methylimino-bis(propylamine) (i.e., N-(3-aminopropyl)-N-methyl-1,3-propanediamine), 1,4-bis(3-aminopropoxy)butane (i.e., 3,3′-[1,4-butanediylbis-(oxy)bis]-1-propanamine), diethyleneglycol-bis(propylamine) (i.e., diethyleneglycol-di(aminopropyl)ether), 4,7,10-trioxatridecane-1,13-diamine, 1-methyl-2,6-diamino-cyclohexane, 1,4-diamino-cyclohexane, poly(oxyethylene-oxypropylene) diamines, 1,3- or 1,4-bis(methylamino)-cyclohexane, isophorone diamine, 1,2- or 1,4-bis(sec-butylamino)-cyclohexane, N,N′-diisopropyl-isophorone diamine, 4,4′-diamino-dicyclohexylmethane, 3,3′-dimethyl-4,4′-diamino-dicyclohexylmethane, 3,3′-dichloro-4,4′-diamino-dicyclohexylmethane, N,N′-dialkylamino-dicyclohexylmethane, polyoxyethylene diamines, 3,3′-diethyl-5,5′-dimethyl-4,4′-diamino-dicyclohexylmethane, polyoxypropylene diamines, 3,3′-diethyl-5,5′-dichloro-4,4′-diamino-dicyclohexylmethane, polytetramethylene ether diamines, 3,3′,5,5 ‘-tetraethyl-4,4’-diamino-dicyclohexylmethane (i.e., 4,4′-methylene-bis(2,6-diethylaminocyclohexane)), 3,3′-dichloro-4,4′-diamino-dicyclohexylmethane, 2,2′-dichloro-3,3′,5,5′-tetraethyl-4,4′-diamino-dicyclohexylmethane, (ethylene oxide)-capped polyoxypropylene ether diamines, 2,2′,3,3′-tetrachloro-4,4′-diamino-dicyclohexylmethane, 4,4′-bis(sec-butylamino)-dicyclohexylmethane; triamines such as diethylene triamine, dipropylene triamine, (propylene oxide)-based triamines (i.e., polyoxypropylene triamines), N-(2-aminoethyl)-1,3-propylenediamine (i.e., N₃-amine), glycerin-based triamines, (all saturated); tetramines such as N,N′-bis(3-aminopropyl)ethylene diamine (i.e., N₄-amine) (both saturated), triethylene tetramine; and other polyamines such as tetraethylene pentamine (also saturated). One suitable amine-terminated chain-extending agent is Ethacure 300™ (dimethylthiotoluenediamine or a mixture of 2,6-diamino-3,5-dimethylthiotoluene and 2,4-diamino-3,5-dimethylthiotoluene.) The amine curing agents used as chain extenders normally have a cyclic structure and a low molecular weight (250 or less).

When the polyurea prepolymer is reacted with amine-terminated curing agents during the chain-extending step, as described above, the resulting composition is essentially a pure polyurea composition. On the other hand, when the polyurea prepolymer is reacted with a hydroxyl-terminated curing agent during the chain-extending step, any excess isocyanate groups in the prepolymer will react with the hydroxyl groups in the curing agent and create urethane linkages to form a polyurea/urethane hybrid.

This chain-extending step, which occurs when the polyurea prepolymer is reacted with hydroxyl curing agents, amine curing agents, or mixtures thereof, builds-up the molecular weight and extends the chain length of the prepolymer. When the polyurea prepolymer is reacted with amine curing agents, a polyurea composition having urea linkages is produced. When the polyurea prepolymer is reacted with hydroxyl curing agents, a polyurea/urethane hybrid composition containing both urea and urethane linkages is produced. The polyurea/urethane hybrid composition is distinct from the pure polyurea composition. The concentration of urea and urethane linkages in the hybrid composition may vary. In general, the hybrid composition may contain a mixture of about 10 to 90% urea and about 90 to 10% urethane linkages. The resulting polyurea or polyurea/urethane hybrid composition has elastomeric properties based on phase separation of the soft and hard segments. The soft segments, which are formed from the polyamine reactants, are generally flexible and mobile, while the hard segments, which are formed from the isocyanates and chain extenders, are generally stiff and immobile.

In an alternative embodiment, the cover layer is formed from a polyurethane or polyurethane/urea hybrid composition. In general, polyurethane compositions contain urethane linkages formed by reacting an isocyanate group (—N═C═O) with a hydroxyl group (OH). The polyurethanes are produced by the reaction of a multi-functional isocyanate (NCO—R—NCO) with a long-chain polyol having terminal hydroxyl groups (OH—OH) in the presence of a catalyst and other additives. The chain length of the polyurethane prepolymer is extended by reacting it with short-chain diols (OH—R′—OH). The resulting polyurethane has elastomeric properties because of its “hard” and “soft” segments, which are covalently bonded together. This phase separation occurs because the mainly non-polar, low melting soft segments are incompatible with the polar, high melting hard segments. The hard segments, which are formed by the reaction of the diisocyanate and low molecular weight chain-extending diol, are relatively stiff and immobile. The soft segments, which are formed by the reaction of the diisocyanate and long chain diol, are relatively flexible and mobile. Because the hard segments are covalently coupled to the soft segments, they inhibit plastic flow of the polymer chains, thus creating elastomeric resiliency.

Suitable isocyanate compounds that can be used to prepare the polyurethane or polyurethane/urea hybrid material are described above. These isocyanate compounds are able to react with the hydroxyl or amine compounds and form a durable and tough polymer having a high melting point. The resulting polyurethane generally has good mechanical strength and cut/shear-resistance. In addition, the polyurethane composition has good light and thermal-stability.

When forming a polyurethane prepolymer, any suitable polyol may be reacted with the above-described isocyanate blends in accordance with this invention. Exemplary polyols include, but are not limited to, polyether polyols, hydroxy-terminated polybutadiene (including partially/fully hydrogenated derivatives), polyester polyols, polycaprolactone polyols, and polycarbonate polyols. In one preferred embodiment, the polyol includes polyether polyol. Examples include, but are not limited to, polytetramethylene ether glycol (PTMEG), polyethylene propylene glycol, polyoxypropylene glycol, and mixtures thereof. The hydrocarbon chain can have saturated or unsaturated bonds and substituted or unsubstituted aromatic and cyclic groups. Preferably, the polyol of the present invention includes PTMEG.

In another embodiment, polyester polyols are included in the polyurethane material. Suitable polyester polyols include, but are not limited to, polyethylene adipate glycol; polybutylene adipate glycol; polyethylene propylene adipate glycol; o-phthalate-1,6-hexanediol; poly(hexamethylene adipate) glycol; and mixtures thereof. The hydrocarbon chain can have saturated or unsaturated bonds, or substituted or unsubstituted aromatic and cyclic groups. In still another embodiment, polycaprolactone polyols are included in the materials of the invention. Suitable polycaprolactone polyols include, but are not limited to: 1,6-hexanediol-initiated polycaprolactone, diethylene glycol initiated polycaprolactone, trimethylol propane initiated polycaprolactone, neopentyl glycol initiated polycaprolactone, 1,4-butanediol-initiated polycaprolactone, and mixtures thereof. The hydrocarbon chain can have saturated or unsaturated bonds, or substituted or unsubstituted aromatic and cyclic groups. In yet another embodiment, polycarbonate polyols are included in the polyurethane material of the invention. Suitable polycarbonates include, but are not limited to, polyphthalate carbonate and poly(hexamethylene carbonate) glycol. The hydrocarbon chain can have saturated or unsaturated bonds, or substituted or unsubstituted aromatic and cyclic groups. In one embodiment, the molecular weight of the polyol is from about 200 to about 4000.

In a manner similar to making the above-described polyurea compositions, there are two basic techniques that can be used to make the polyurethane compositions of this invention: a) one-shot technique, and b) prepolymer technique. In the one-shot technique, the isocyanate blend, polyol, and hydroxyl-terminated and/or amine-terminated chain-extender (curing agent) are reacted in one step. On the other hand, the prepolymer technique involves a first reaction between the isocyanate blend and polyol compounds to produce a polyurethane prepolymer, and a subsequent reaction between the prepolymer and hydroxyl-terminated and/or amine-terminated chain-extender. As a result of the reaction between the isocyanate and polyol compounds, there will be some unreacted NCO groups in the polyurethane prepolymer. The prepolymer should have less than 14% unreacted NCO groups. Preferably, the prepolymer has no greater than 8.5% unreacted NCO groups, more preferably from 2.5% to 8%, and most preferably from 5.0% to 8.0% unreacted NCO groups. As the weight percent of unreacted isocyanate groups increases, the hardness of the composition also generally increases.

Either the one-shot or prepolymer method may be employed to produce the polyurethane compositions of the invention. In one embodiment, the one-shot method is used, wherein the isocyanate compound is added to a reaction vessel and then a curative mixture comprising the polyol and curing agent is added to the reaction vessel. The components are mixed together so that the molar ratio of isocyanate groups to hydroxyl groups is in the range of about 1.01:1.00 to about 1.10:1.00. Preferably, the molar ratio is greater than or equal to 1.05:1.00. For example, the molar ratio can be in the range of 1.05:1.00 to 1.10:1.00. In a second embodiment, the prepolymer method is used. In general, the prepolymer technique is preferred because it provides better control of the chemical reaction. The prepolymer method provides a more homogeneous mixture resulting in a more consistent polymer composition. The one-shot method results in a mixture that is inhomogeneous (more random) and affords the manufacturer less control over the molecular structure of the resultant composition.

The polyurethane compositions can be formed by chain-extending the polyurethane prepolymer with a single curing agent (chain-extender) or blend of curing agents (chain-extenders) as described further below. The compositions of the present invention may be selected from among both castable thermoplastic and thermoset polyurethanes. Thermoplastic polyurethane compositions are typically formed by reacting the isocyanate blend and polyols at a 1:1 stoichiometric ratio. Thermoset compositions, on the other hand, are cross-linked polymers and are typically produced from the reaction of the isocyanate blend and polyols at normally a 1.05:1 stoichiometric ratio. In general, thermoset polyurethane compositions are easier to prepare than thermoplastic polyurethanes.

As discussed above, the polyurethane prepolymer can be chain-extended by reacting it with a single chain-extender or blend of chain-extenders. In general, the prepolymer can be reacted with hydroxyl-terminated curing agents, amine-terminated curing agents, and mixtures thereof. The curing agents extend the chain length of the prepolymer and build-up its molecular weight. Normally, the prepolymer and curing agent are mixed so the isocyanate groups and hydroxyl or amine groups are mixed at a 1.05:1.00 stoichiometric ratio.

A catalyst may be employed to promote the reaction between the isocyanate and polyol compounds for producing the polyurethane prepolymer or between the polyurethane prepolymer and chain-extender during the chain-extending step. Preferably, the catalyst is added to the reactants before producing the polyurethane prepolymer. Suitable catalysts include, but are not limited to, the catalysts described above for making the polyurea prepolymer. The catalyst is preferably added in an amount sufficient to catalyze the reaction of the components in the reactive mixture. In one embodiment, the catalyst is present in an amount from about 0.001 percent to about 1 percent, and preferably 0.1 to 0.5 percent, by weight of the composition.

Suitable hydroxyl chain-extending (curing) agents and amine chain-extending (curing) agents include, but are not limited to, the curing agents described above for making the polyurea and polyurea/urethane hybrid compositions. When the polyurethane prepolymer is reacted with hydroxyl-terminated curing agents during the chain-extending step, as described above, the resulting polyurethane composition contains urethane linkages. On the other hand, when the polyurethane prepolymer is reacted with amine-terminated curing agents during the chain-extending step, any excess isocyanate groups in the prepolymer will react with the amine groups in the curing agent. The resulting polyurethane composition contains urethane and urea linkages and may be referred to as a polyurethane/urea hybrid. The concentration of urethane and urea linkages in the hybrid composition may vary. In general, the hybrid composition may contain a mixture of about 10 to 90% urethane and about 90 to 10% urea linkages.

Golf balls of the invention and any thermoplastic or thermoset layer disclosed herein may be formed using a variety of application techniques such as compression molding, flip molding, injection molding, retractable pin injection molding, reaction injection molding (RIM), liquid injection molding (LIM), casting, vacuum forming, powder coating, flow coating, spin coating, dipping, spraying, and the like. Conventionally, compression molding and injection molding are applied to thermoplastic materials, whereas RIM, liquid injection molding, and casting are employed on thermoset materials. These and other manufacture methods are disclosed in U.S. Pat. Nos. 6,207,784 and 5,484,870, the disclosures of which are incorporated herein by reference in their entireties.

A method of injection molding using a split vent pin can be found in co-pending U.S. Pat. No. 6,877,974, filed Dec. 22, 2000, entitled “Split Vent Pin for Injection Molding.” Examples of retractable pin injection molding may be found in U.S. Pat. Nos. 6,129,881; 6,235,230; and 6,379,138. These molding references are incorporated in their entirety by reference herein. In addition, a chilled chamber, i.e., a cooling jacket, such as the one disclosed in U.S. Pat. No. 6,936,205, filed Nov. 22, 2000, entitled “Method of Making Golf Balls” may be used to cool the compositions of the invention when casting, which also allows for a higher loading of catalyst into the system.

Conventionally, compression molding and injection molding are applied to thermoplastic materials, whereas RIM, liquid injection molding, and casting are employed on thermoset materials. These and other manufacture methods are disclosed in U.S. Pat. Nos. 6,207,784 and 5,484,870, the disclosures of which are incorporated herein by reference in their entirety.

Castable reactive liquid polyurethanes and polyurea materials may be applied over the inner ball using a variety of application techniques such as casting, injection molding spraying, compression molding, dipping, spin coating, or flow coating methods that are well known in the art. In one embodiment, the castable reactive polyurethanes and polyurea material is formed over the core using a combination of casting and compression molding. Conventionally, compression molding and injection molding are applied to thermoplastic cover materials, whereas RIM, liquid injection molding, and casting are employed on thermoset cover materials.

U.S. Pat. No. 5,733,428, the entire disclosure of which is hereby incorporated by reference, discloses a method for forming a polyurethane cover on a golf ball core. Because this method relates to the use of both casting thermosetting and thermoplastic material as the golf ball cover, wherein the cover is formed around the core by mixing and introducing the material in mold halves, the polyurea compositions may also be used employing the same casting process.

For example, once a polyurea composition is mixed, an exothermic reaction commences and continues until the material is solidified around the core. It is important that the viscosity be measured over time, so that the subsequent steps of filling each mold half, introducing the core into one half and closing the mold can be properly timed for accomplishing centering of the core cover halves fusion and achieving overall uniformity. A suitable viscosity range of the curing urea mix for introducing cores into the mold halves is determined to be approximately between about 2,000 cP and about 30,000 cP, or within a range of about 8,000 cP to about 15,000 cP.

To start the cover formation, mixing of the prepolymer and curative is accomplished in a motorized mixer inside a mixing head by feeding through lines metered amounts of curative and prepolymer. Top preheated mold halves are filled and placed in fixture units using centering pins moving into apertures in each mold. At a later time, the cavity of a bottom mold half, or the cavities of a series of bottom mold halves, is filled with similar mixture amounts as used for the top mold halves. After the reacting materials have resided in top mold halves for about 40 to about 100 seconds, preferably for about 70 to about 80 seconds, a core is lowered at a controlled speed into the gelling reacting mixture.

A ball cup holds the shell through reduced pressure (or partial vacuum). Upon location of the core in the halves of the mold after gelling for about 4 to about 12 seconds, the vacuum is released allowing the core to be released. In one embodiment, the vacuum is released allowing the core to be released after about 5 seconds to 10 seconds. The mold halves, with core and solidified cover half thereon, are removed from the centering fixture unit, inverted and mated with second mold halves which, at an appropriate time earlier, have had a selected quantity of reacting polyurea prepolymer and curing agent introduced therein to commence gelling.

Similarly, U.S. Pat. No. 5,006,297 and U.S. Pat. No. 5,334,673 both also disclose suitable molding techniques that may be utilized to apply the castable reactive liquids employed in the present invention.

However, golf balls of the invention may be made by any known technique to those skilled in the art.

Examples of yet other materials which may be suitable for incorporating and coordinating in order to target and achieve desired playing characteristics or feel include plasticized thermoplastics, polyalkenamer compositions, polyester-based thermoplastic elastomers containing plasticizers, transparent or plasticized polyamides, thiolene compositions, poly-amide and anhydride-modified polyolefins, organic acid-modified polymers, and the like.

Meanwhile, the dimensions of each golf ball component such as the diameter of the core and respective thicknesses of the intermediate layer (s), cover layer(s) and coating layer(s) may be selected and coordinated for targeting and achieving desired playing characteristics or feel. Golf balls made in accordance with this invention can be of any size, although the USGA requires that golf balls used in competition have a diameter of at least 1.68 inches. For play outside of United States Golf Association (USGA) rules, the golf balls can be of a smaller size. Normally, golf balls are manufactured in accordance with USGA requirements and have a diameter in the range of about 1.68 to about 1.80 inches. Also, the USGA has established a maximum weight of 45.93 g (1.62 ounces) for golf balls. For play outside of USGA rules, the golf balls can be heavier.

Golf balls having various constructions may be made in accordance with this invention. For example, golf balls having one-piece, two-piece, three-piece, four-piece, and five or more-piece constructions, with the term “piece” referring to any core, cover or intermediate layer of a golf ball construction, may be made. The term, “layer” as used herein means generally any spherical portion of the golf ball.

In one version, a one-piece ball is made using the inventive composition as the entire golf ball excluding any paint or coating and indicia applied thereon. In a second version, a two-piece ball comprising a single core and a single cover layer is made.

In a third version, a three-piece golf ball contains a dual-layered core and a single-layered cover. The dual-core includes an inner core (center) and surrounding outer core layer. In another version, a three-piece ball contains a single core layer and two cover layers. In yet another version, a four-piece golf ball contains a dual-core and dual-cover (inner cover layer and outer cover layer).

In yet another construction, a four-piece or five-piece golf ball contains a dual-core; an inner cover layer, an intermediate cover layer, and an outer cover layer. In still another construction, a five-piece ball is made containing a three-layered core with an innermost core layer (or center), an intermediate core layer, and outer core layer, and a two-layered cover with an inner and outer cover layer.

The diameter and thickness of the different layers along with properties such as hardness and compression may vary depending upon the construction and desired playing performance properties of the golf ball. Any one or more of the layers of any of the one, two, three, four, or five, or more-piece (layered) balls described above may comprise a non-isocyanate-containing polyurethane composition. That is, any of the layers in the core assembly (for example, inner (center), intermediate, and/or outer core layers), and/or any of the layers in the cover assembly (for example, inner, intermediate, and/or outer cover layers) may comprise a non-isocyanate-containing polyurethane composition.

For example, the core may have an overall diameter of from about 1.47 inches (in.) to about 1.62 in., with outer core layers having thicknesses of up to 0.400 or greater; intermediate/casing layer(s) having a thicknesses, for example, of from about 0.025 in. to about 0.057 in.; the core and intermediate/casing layer, combined, having an outer diameter of from about 1.57 in. to about 1.65 in.; covers having a thicknesses of from about 0.015 in. to about 0.055 in.; and coating layers having a combined thickness of from about 0.1 μm to about 100 μm, or from about 2 μm to about 50 μm, or from about 2 μm to about 30 μm. Meanwhile, each coating layer may have a thickness of from about 0.1 μm to about 50 μm, or from about 0.1 μm to about 25 μm, or from about 0.1 μm to about 14 μm, or from about 2 μm to about 9 μm, for example.

In some embodiments, the core may have an overall diameter within a range having a lower limit of 0.500 or 0.700 or 0.750 or 0.800 or 0.850 or 0.900 or 0.950 or 1.000 or 1.100 or 1.150 or 1.200 or 1.250 or 1.300 or 1.350 or 1.400 or 1.450 or 1.500 or 1.600 or 1.610 inches and an upper limit of 1.620 or 1.630 or 1.640 inches. In a particular embodiment, the core is a multi-layer core having an overall diameter within a range having a lower limit of 0.500 or 0.700 or 0.750 or 0.800 or 0.850 or 0.900 or 0.950 or 1.000 or 1.100 or 1.150 or 1.200 inches and an upper limit of 1.250 or 1.300 or 1.350 or 1.400 or 1.450 or 1.500 or 1.600 or 1.610 or 1.620 or 1.630 or 1.640 inches. In another particular embodiment, the multi-layer core has an overall diameter within a range having a lower limit of 0.500 or 0.700 or 0.750 inches and an upper limit of 0.800 or 0.850 or 0.900 or 0.950 or 1.000 or 1.100 or 1.150 or 1.200 or 1.250 or 1.300 or 1.350 or 1.400 or 1.450 or 1.500 or 1.600 or 1.610 or 1.620 or 1.630 or 1.640 inches. In another particular embodiment, the multi-layer core has an overall diameter of 1.500 inches or 1.510 inches or 1.530 inches or 1.550 inches or 1.570 inches or 1.580 inches or 1.590 inches or 1.600 inches or 1.610 inches or 1.620 inches.

The inner core can have an overall diameter of 0.500 inches or greater, or 0.700 inches or greater, or 1.00 inches or greater, or 1.250 inches or greater, or 1.350 inches or greater, or 1.390 inches or greater, or 1.450 inches or greater, or an overall diameter within a range having a lower limit of 0.250 or 0.500 or 0.750 or 1.000 or 1.250 or 1.350 or 1.390 or 1.400 or 1.440 inches and an upper limit of 1.460 or 1.490 or 1.500 or 1.550 or 1.580 or 1.600 inches, or an overall diameter within a range having a lower limit of 0.250 or 0.300 or 0.350 or 0.400 or 0.500 or 0.550 or 0.600 or 0.650 or 0.700 inches and an upper limit of 0.750 or 0.800 or 0.900 or 0.950 or 1.000 or 1.100 or 1.150 or 1.200 or 1.250 or 1.300 or 1.350 or 1.400 inches. In one embodiment, the inner core consists of a single layer formed from a thermoset rubber composition. In another embodiment, the inner core consists of two layers, each of which is formed from the same or different thermoset rubber compositions. In another embodiment, the inner core comprises three or more layers, each of which is formed from the same or different thermoset rubber compositions. In another embodiment, the inner core consists of a single layer formed from a thermoplastic composition. In another embodiment, the inner core consists of two layers, each of which is formed from the same or different thermoplastic compositions. In another embodiment, the inner core comprises three or more layers, each of which is formed from the same or different thermoplastic compositions. In a particular embodiment, the inner core has one or more of the following properties:
a) a center hardness within a range having a lower limit of 20 or 25 or 30 or 35 or 40 or 45 or 50 or 55 Shore C and an upper limit of 60 or 65 or 70 or 75 or 90 Shore C;
b) an outer surface hardness within a range having a lower limit of 20 or 50 or 70 or 75 Shore C and an upper limit of 75 or 80 or 85 or 90 or 95 Shore C;
c) a negative hardness gradient, a zero hardness gradient, or a positive hardness gradient of up to 45 Shore C; and
d) an overall compression of 90 or less, or 80 or less, or 70 or less, or 60 or less, or 50 or less, or 40 or less, or 20 or less, or a compression within a range having a lower limit of 10 or 20 or 30 or 35 or 40 and an upper limit of 50 or 60 or 70 or 80 or 90.

An intermediate core layer can have an overall thickness within a range having a lower limit of 0.005 or 0.010 or 0.015 or 0.020 or 0.025 or 0.030 or 0.035 or 0.040 or 0.045 inches and an upper limit of 0.050 or 0.055 or 0.060 or 0.065 or 0.070 or 0.075 or 0.080 or 0.090 or 0.100 inches. In one embodiment, the intermediate core consists of a single layer formed from a thermoset rubber composition. In another embodiment, the intermediate core consists of two layers, each of which is formed from the same or different thermoset rubber compositions. In another embodiment, the intermediate core comprises three or more layers, each of which is formed from the same or different thermoset rubber compositions. In another embodiment, the intermediate core consists of a single layer formed from a thermoplastic composition. In another embodiment, the intermediate core consists of two layers, each of which is formed from the same or different thermoplastic compositions. In another embodiment, the intermediate core comprises three or more layers, each of which is formed from the same or different thermoplastic compositions. In a particular embodiment, the intermediate core has one or more of the following properties:
a) a surface hardness of 25 Shore C or greater, or 40 Shore C or greater, or a surface hardness within a range having a lower limit of 25 or 30 or 35 Shore C and an upper limit of 80 or 85 Shore C;
b) a surface hardness of 60 Shore D or less, or less than 60 Shore D, or 55 Shore D or less, or less than 55 Shore D;
c) a surface hardness within a range having a lower limit of 20 or 30 or 35 or 45 Shore D and an upper limit of 55 or 60 or 65 Shore D;
d) a surface hardness of greater than 60 Shore D;
e) a surface hardness greater than the surface hardness of both the inner core and the outer core.

The outer core layer can have an overall thickness within a range having a lower limit of 0.010 or 0.020 or 0.025 or 0.030 or 0.035 inches and an upper limit of 0.040 or 0.070 or 0.075 or 0.080 or 0.100 or 0.150 inches, or an overall thickness within a range having a lower limit of 0.025 or 0.050 or 0.100 or 0.150 or 0.160 or 0.170 or 0.200 inches and an upper limit of 0.225 or 0.250 or 0.275 or 0.300 or 0.325 or 0.350 or 0.400 or 0.450 or greater than 0.450 inches. The outer core layer may alternatively have a thickness of greater than 0.10 inches, or 0.20 inches or greater, or greater than 0.20 inches, or 0.30 inches or greater, or greater than 0.30 inches, or 0.35 inches or greater, or greater than 0.35 inches, or 0.40 inches or greater, or greater than 0.40 inches, or 0.45 inches or greater, or greater than 0.45 inches, or a thickness within a range having a lower limit of 0.005 or 0.010 or 0.015 or 0.020 or 0.025 or 0.030 or 0.035 or 0.040 or 0.045 or 0.050 or 0.055 or 0.060 or 0.065 or 0.070 or 0.075 or 0.080 or 0.090 or 0.100 or 0.200 or 0.250 inches and an upper limit of 0.300 or 0.350 or 0.400 or 0.450 or 0.500 inches.

In one embodiment, the outer core consists of a single layer formed from a thermoset rubber composition. In another embodiment, the outer core consists of two layers, each of which is formed from the same or different thermoset rubber compositions. In another embodiment, the outer core comprises three or more layers, each of which is formed from the same or different thermoset rubber compositions. In another embodiment, the outer core consists of a single layer formed from a thermoplastic composition. In another embodiment, the outer core consists of two layers, each of which is formed from the same or different thermoplastic compositions. In another embodiment, the outer core comprises three or more layers, each of which is formed from the same or different thermoplastic compositions. In a particular embodiment, the outer core has one or more of the following properties:
a) a thickness of 0.035 inches or 0.040 inches or 0.045 inches or 0.050 inches or 0.055 inches or 0.060 inches or 0.065 inches;
b) a surface hardness of 45 Shore C or greater, or 70 Shore C or greater, or 75 Shore C or greater, or 80 Shore C or greater, or a surface hardness within a range having a lower limit of 45 or 70 or 80 Shore C and an upper limit of 90 or 95 Shore C;
c) a surface hardness greater than the surface hardness of the inner core;
d) a surface hardness less than the surface hardness of the inner core;
e) a surface hardness of 20 Shore C or greater, or 30 Shore C or greater, or 35 Shore C or greater, or 40 Shore C or greater, or a surface hardness within a range having a lower limit of 20 or 30 or 35 or 40 or 50 Shore C and an upper limit of 60 or 70 or 80 Shore C;
f) a surface hardness within a range having a lower limit of 50 or 55 or 60 or 62 or 65 Shore D and an upper limit of 65 or 70 Shore D;
g) is formed from a rubber composition selected from those disclosed in U.S. Patent Application Publication Nos. 2009/0011857 and 2009/0011862, the entire disclosures of which are hereby incorporated herein by reference.

The multi-layer core is enclosed with a cover, which may be a single-, dual-, or multi-layer cover, preferably having an overall thickness within a range having a lower limit of 0.010 or 0.020 or 0.025 or 0.030 or 0.040 or 0.045 inches and an upper limit of 0.050 or 0.060 or 0.070 or 0.075 or 0.080 or 0.090 or 0.100 or 0.150 or 0.200 or 0.300 or 0.500 inches. In a particular embodiment, the cover is a single layer having a thickness of from 0.010 or 0.020 or 0.025 inches to 0.035 or 0.040 or 0.050 inches. In another particular embodiment, the cover consists of an inner cover layer having a thickness of from 0.010 or 0.020 or 0.025 inches to 0.035 or 0.050 inches and an outer cover layer having a thickness of from 0.010 or 0.020 or 0.025 inches to 0.035 or 0.040 inches.

In one embodiment, the cover is a single layer having a surface hardness of 60 Shore D or greater, or 65 Shore D or greater. In a particular aspect of this embodiment, the cover is formed from a composition having a material hardness of 60 Shore D or greater, or 65 Shore D or greater.

In another particular embodiment, the cover is a single layer having a thickness of from 0.010 or 0.020 inches to 0.035 or 0.050 inches and formed from an ionomeric composition having a material hardness of from 60 or 62 or 65 Shore D to 65 or 70 or 72 Shore D.

In another particular embodiment, the cover is a single layer having a thickness of from 0.010 or 0.025 inches to 0.035 or 0.040 inches and formed from a thermoplastic composition selected from ionomer-, polyurethane-, and polyurea-based compositions having a material hardness of 62 Shore D or less, or less than 62 Shore D, or 60 Shore D or less, or less than 60 Shore D, or 55 Shore D or less, or less than 55 Shore D.

In another particular embodiment, the cover is a single layer having a thickness of from 0.010 or 0.025 inches to 0.035 or 0.040 inches and formed from a thermosetting polyurethane- or polyurea-based composition having a material hardness of 62 Shore D or less, or less than 62 Shore D, or 60 Shore D or less, or less than 60 Shore D, or 55 Shore D or less, or less than 55 Shore D.

In another particular embodiment, the cover comprises an inner cover layer formed from an ionomeric composition and an outer cover layer formed from a thermosetting polyurethane- or polyurea-based composition. The inner cover layer composition preferably has a material hardness of from 60 or 62 or 65 Shore D to 65 or 70 or 72 Shore D. The inner cover layer preferably has a thickness within a range having a lower limit of 0.010 or 0.020 or 0.030 inches and an upper limit of 0.035 or 0.040 or 0.050 inches. The outer cover layer composition preferably has a material hardness of 62 Shore D or less, or less than 62 Shore D, or 60 Shore D or less, or less than 60 Shore D, or 55 Shore D or less, or less than 55 Shore D. The outer cover layer preferably has a thickness within a range having a lower limit of 0.010 or 0.020 or 0.025 inches and an upper limit of 0.035 or 0.040 or 0.050 inches.

In another particular embodiment, the cover comprises an inner cover layer formed from an ionomeric composition and an outer cover layer formed from a thermoplastic composition selected from ionomer-, polyurethane-, and polyurea-based compositions. The inner cover layer composition preferably has a material hardness of from 60 or 62 or 65 Shore D to 65 or 70 or 72 Shore D. The inner cover layer preferably has a thickness within a range having a lower limit of 0.010 or 0.020 or 0.030 inches and an upper limit of 0.035 or 0.040 or 0.050 inches. The outer cover layer composition preferably has a material hardness of 62 Shore D or less, or less than 62 Shore D, or 60 Shore D or less, or less than 60 Shore D, or 55 Shore D or less, or less than 55 Shore D. The outer cover layer preferably has a thickness within a range having a lower limit of 0.010 or 0.020 or 0.025 inches and an upper limit of 0.035 or 0.040 or 0.050 inches.

In another particular embodiment, the cover is a dual- or multi-layer cover including an inner or intermediate cover layer formed from an ionomeric composition and an outer cover layer formed from a polyurethane- or polyurea-based composition. The ionomeric layer preferably has a surface hardness of 70 Shore D or less, or 65 Shore D or less, or less than 65 Shore D, or a Shore D hardness of from 50 to 65, or a Shore D hardness of from 57 to 60, or a Shore D hardness of 58, and a thickness within a range having a lower limit of 0.010 or 0.020 or 0.030 inches and an upper limit of 0.045 or 0.080 or 0.120 inches. The outer cover layer is preferably formed from a castable or reaction injection moldable polyurethane, polyurea, or copolymer or hybrid of polyurethane/polyurea. Such cover material is preferably thermosetting, but may be thermoplastic. The outer cover layer composition preferably has a material hardness of 85 Shore C or less, or 45 Shore D or less, or 40 Shore D or less, or from 25 Shore D to 40 Shore D, or from 30 Shore D to 40 Shore D. The outer cover layer preferably has a surface hardness within a range having a lower limit of 20 or 30 or 35 or 40 Shore D and an upper limit of 52 or 58 or 60 or 65 or 70 or 72 or 75 Shore D. The outer cover layer preferably has a thickness within a range having a lower limit of 0.010 or 0.015 or 0.025 inches and an upper limit of 0.035 or 0.040 or 0.045 or 0.050 or 0.055 or 0.075 or 0.080 or 0.115 inches.

In another particular embodiment, the cover comprises an inner cover layer formed from an ionomeric composition and an outer cover layer formed from a thermosetting polyurethane- or polyurea-based composition. The inner cover layer composition preferably has a material hardness of from 60 or 62 or 65 Shore D to 65 or 70 or 72 Shore D. The inner cover layer preferably has a thickness within a range having a lower limit of 0.010 or 0.020 or 0.030 inches and an upper limit of 0.035 or 0.040 or 0.050 inches. The outer cover layer composition preferably has a material hardness of 62 Shore D or less, or less than 62 Shore D, or 60 Shore D or less, or less than 60 Shore D, or 55 Shore D or less, or less than 55 Shore D. The outer cover layer preferably has a thickness within a range having a lower limit of 0.010 or 0.020 or 0.025 inches and an upper limit of 0.035 or 0.040 or 0.050 inches.

In another particular embodiment, the cover comprises an inner cover layer formed from an ionomeric composition and an outer cover layer formed from a thermoplastic composition selected from ionomer-, polyurethane-, and polyurea-based compositions. The inner cover layer composition preferably has a material hardness of from 60 or 62 or 65 Shore D to 65 or 70 or 72 Shore D. The inner cover layer preferably has a thickness within a range having a lower limit of 0.010 or 0.020 or 0.030 inches and an upper limit of 0.035 or 0.040 or 0.050 inches. The outer cover layer composition preferably has a material hardness of 62 Shore D or less, or less than 62 Shore D, or 60 Shore D or less, or less than 60 Shore D, or 55 Shore D or less, or less than 55 Shore D. The outer cover layer preferably has a thickness within a range having a lower limit of 0.010 or 0.020 or 0.025 inches and an upper limit of 0.035 or 0.040 or 0.050 inches.

In another particular embodiment, the cover is a dual- or multi-layer cover including an inner or intermediate cover layer formed from an ionomeric composition and an outer cover layer formed from a polyurethane- or polyurea-based composition. The ionomeric layer preferably has a surface hardness of 70 Shore D or less, or 65 Shore D or less, or less than 65 Shore D, or a Shore D hardness of from 50 to 65, or a Shore D hardness of from 57 to 60, or a Shore D hardness of 58, and a thickness within a range having a lower limit of 0.010 or 0.020 or 0.030 inches and an upper limit of 0.045 or 0.080 or 0.120 inches. The outer cover layer is preferably formed from a castable or reaction injection moldable polyurethane, polyurea, or copolymer or hybrid of polyurethane/polyurea. Such cover material is preferably thermosetting, but may be thermoplastic. The outer cover layer composition preferably has a material hardness of 85 Shore C or less, or 45 Shore D or less, or 40 Shore D or less, or from 25 Shore D to 40 Shore D, or from 30 Shore D to 40 Shore D. The outer cover layer preferably has a surface hardness within a range having a lower limit of 20 or 30 or 35 or 40 Shore D and an upper limit of 52 or 58 or 60 or 65 or 70 or 72 or 75 Shore D. The outer cover layer preferably has a thickness within a range having a lower limit of 0.010 or 0.015 or 0.025 inches and an upper limit of 0.035 or 0.040 or 0.045 or 0.050 or 0.055 or 0.075 or 0.080 or 0.115 inches.

The CoR of each golf ball layer may meanwhile also be targeted and the respective CoRs of the layers coordinated with each other to form an over golf ball possessing/displaying desired playing characteristics. The CoR of a particular golf ball layer may be targeted, for example, to be 0.450 or greater, or 0.475 or greater, or 0.500 or greater, or 0.525 or greater, or 0.550 or greater, or 0.575 or greater, or 0.600 or greater, or 0.625 or greater, or 0.650 or greater, or 0.675 or greater, or 0.700 or greater, or 0.725 or greater, or 0.750 or greater, or 0.800 or greater, or 0.825 or greater, or 0.850 or greater, or 0.825 or greater, or 0.850 or greater, or 0.875 or greater. Embodiments are also envisioned wherein the CoR of a particular layer can be less than 0.450.

The overall coefficient of restitution (“CoR”) of some cores of the present invention at 125 ft/s is at least 0.750, or at least 0.775 or at least 0.780, or at least 0.782, or at least 0.785, or at least 0.787, or at least 0.790, or at least 0.795, or at least 0.798, or at least 0.800. Golf balls of the present invention typically have a golf ball CoR of 0.700 or greater, preferably 0.750 or greater, and more preferably 0.780 or greater. Golf balls of the present invention typically have a compression of 40 or greater, or a compression within a range having a lower limit of 50 or 60 and an upper limit of 100 or 120. However, in some embodiments, at least one golf ball layer may have a compression of less than 40.

Golf ball properties such as compression and hardness may be measured as follows. For purposes of the present invention, “compression” refers to Atti compression and is measured according to a known procedure, using an Atti compression test device, wherein a piston is used to compress a ball against a spring. The travel of the piston is fixed and the deflection of the spring is measured. The measurement of the deflection of the spring does not begin with its contact with the ball; rather, there is an offset of approximately the first 1.25 mm (0.05 inches) of the spring's deflection. Very low compression cores will not cause the spring to deflect by more than 1.25 mm and therefore have a zero or negative compression measurement. The Atti compression tester is designed to measure objects having a diameter of 1.680 inches; thus, smaller objects, such as golf ball cores, must be shimmed to a total height of 1.680 inches to obtain an accurate reading. Conversion from Atti compression to Riehle (cores), Riehle (balls), 100 kg deflection, 130-10 kg deflection or effective modulus can be carried out according to the formulas given in Compression by Any Other Name, Science and Golf IV, Proceedings of the World Scientific Congress of Golf (Eric Thain ed., Routledge, 2002).

The center hardness of a core is obtained according to the following procedure. The core is gently pressed into a hemispherical holder having an internal diameter approximately slightly smaller than the diameter of the core, such that the core is held in place in the hemispherical portion of the holder while concurrently leaving the geometric central plane of the core exposed. The core is secured in the holder by friction, such that it will not move during the cutting and grinding steps, but the friction is not so excessive that distortion of the natural shape of the core would result. The core is secured such that the parting line of the core is roughly parallel to the top of the holder. The diameter of the core is measured 90 degrees to this orientation prior to securing. A measurement is also made from the bottom of the holder to the top of the core to provide a reference point for future calculations. A rough cut is made slightly above the exposed geometric center of the core using a band saw or other appropriate cutting tool, making sure that the core does not move in the holder during this step. The remainder of the core, still in the holder, is secured to the base plate of a surface grinding machine. The exposed ‘rough’ surface is ground to a smooth, flat surface, revealing the geometric center of the core, which can be verified by measuring the height from the bottom of the holder to the exposed surface of the core, making sure that exactly half of the original height of the core, as measured above, has been removed to within ±0.004 inches. Leaving the core in the holder, the center of the core is found with a center square and carefully marked and the hardness is measured at the center mark according to ASTM D-2240. Additional hardness measurements at any distance from the center of the core can then be made by drawing a line radially outward from the center mark, and measuring the hardness at any given distance along the line, typically in 2 mm increments from the center. The hardness at a particular distance from the center should be measured along at least two, preferably four, radial arms located 180° apart, or 90° apart, respectively, and then averaged. All hardness measurements performed on a plane passing through the geometric center are performed while the core is still in the holder and without having disturbed its orientation, such that the test surface is constantly parallel to the bottom of the holder, and thus also parallel to the properly aligned foot of the durometer.

Hardness points should only be measured once at any particular geometric location.

The surface hardness of a golf ball layer is obtained from the average of a number of measurements taken from opposing hemispheres, taking care to avoid making measurements on the parting line of the core or on surface defects such as holes or protrusions. Hardness measurements are made pursuant to ASTM D-2240 “Indentation Hardness of Rubber and Plastic by Means of a Durometer.” Because of the curved surface of the golf ball layer, care must be taken to ensure that the golf ball or golf ball subassembly is centered under the durometer indentor before a surface hardness reading is obtained. A calibrated digital durometer, capable of reading to 0.1 hardness units, is used for all hardness measurements. The digital durometer must be attached to and its foot made parallel to the base of an automatic stand. The weight on the durometer and attack rate conforms to ASTM D-2240. It should be understood that there is a fundamental difference between “material hardness” and “hardness as measured directly on a golf ball.” For purposes of the present invention, material hardness is measured according to ASTM D2240 and generally involves measuring the hardness of a flat “slab” or “button” formed of the material. Surface hardness as measured directly on a golf ball (or other spherical surface) typically results in a different hardness value. The difference in “surface hardness” and “material hardness” values is due to several factors including, but not limited to, ball construction (that is, core type, number of cores and/or cover layers, and the like); ball (or sphere) diameter; and the material composition of adjacent layers. It also should be understood that the two measurement techniques are not linearly related and, therefore, one hardness value cannot easily be correlated to the other.

It should be understood that there is a fundamental difference between “material hardness” and “hardness as measured directly on a golf ball.” For purposes of the present disclosure, material hardness is measured according to ASTM D2240 and generally involves measuring the hardness of a flat “slab” or “button” formed of the material. Hardness as measured directly on a golf ball (or other spherical surface) typically results in a different hardness value. This difference in hardness values is due to several factors including, but not limited to, ball construction (i.e., core type, number of core and/or cover layers, etc.), ball (or sphere) diameter, and the material composition of adjacent layers. It should also be understood that the two measurement techniques are not linearly related and, therefore, one hardness value cannot easily be correlated to the other.

It is understood that the golf balls of the invention incorporating at least one core layer consisting of a non-isocyanate-containing polyurethane composition or NIPU, as described and illustrated herein, represent only some of the many embodiments of the invention. It is appreciated by those skilled in the art that various changes and additions can be made to such golf balls without departing from the spirit and scope of this invention. It is intended that all such embodiments be covered by the appended claims.

A golf ball of the invention may also incorporate indicia such as any symbol, letter, group of letters, design, or the like, that can be added to the dimpled surface of a golf ball.

It will be appreciated that any known dimple pattern may be used with any number of dimples having any shape or size. For example, the number of dimples may be 252 to 456, or 330 to 392 and may comprise any width, depth, and edge angle. The parting line configuration of said pattern may be either a straight line or a staggered wave parting line (SWPL).

In any of these embodiments the single-layer core may be replaced with a 2 or more layer core wherein at least one core layer has a hardness gradient.

Other than in the operating examples, or unless otherwise expressly specified, all of the numerical ranges, amounts, values and percentages such as those for amounts of materials and others in the specification may be read as if prefaced by the word “about” even though the term “about” may not expressly appear with the value, amount or range. Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements. Furthermore, when numerical ranges of varying scope are set forth herein, it is contemplated that any combination of these values inclusive of the recited values may be used.

Although the golf ball of the invention has been described herein with reference to particular means and materials, it is to be understood that the invention is not limited to the particulars disclosed and extends to all equivalents within the scope of the claims.

1. A golf ball comprising at least one layer consisting of a non-isocyanate-containing polyurethane composition comprising the reaction product of at least one amine or polyamine having an average functionality of 2.0 or greater, and at least one cyclo-carbonate.

2. The golf ball of claim 1, wherein the at least one cyclo-carbonate comprises bis(cyclo-carbonate).

3. The golf ball of claim 2, wherein the at least one amine is selected from the group consisting of: ethylenediamine, hexamethylenediamine, or tris(2-aimnoethyl)amine, or blends thereof.

4. The golf ball of claim 3, wherein the at least one polyamine is selected from the group consisting of polyoxypropylene diamines, polyoxypropylene triamines, and combinations thereof.

5. The golf ball of claim 1, wherein the at least one layer is a core layer.

6. The golf ball of claim 1, wherein the at least one layer is an intermediate layer disposed about a thermoset core.

7. The golf ball of claim 1, wherein the at least one layer is a cover layer.

8. The golf ball of claim 1, wherein the at least one layer is a coating layer that is formed about an outermost cover layer of the golf ball.

9. The golf ball of claim 1, wherein the at least one layer is a tie layer that is disposed between and adjacent to two differing golf ball layers that do not comprise the non-isocyanate-containing polyurethane composition.

10. The golf ball of claim 1, wherein the non-isocyanate-containing polyurethane composition further comprises density-adjusting fillers, process aides, plasticizers, blowing or foaming agents, fillers such as metal powder, metal alloy powder, metal oxide, metal stearates, particulates, flakes, fibers, carbonaceous material, or combinations thereof.

11. A golf ball comprising at least one layer consisting of a non-isocyanate-containing polyurethane composition comprising the reaction product of at least one amine or polyamine, having an average functionality of 2.0 or greater, and at least one epoxy-cyclo-carbonate oligomer.

12. The golf ball of claim 11, wherein the non-isocyanate-containing polyurethane composition is modified with at least one of acrylic or siloxane.

13. The golf ball of claim 11, wherein the at least one layer is a cover layer.

14. The golf ball of claim 11, wherein the at least one layer is a coating layer that is formed about an outermost cover layer of the golf ball.

15. The golf ball of claim 11, wherein the at least one layer is a tie layer that is disposed between and adjacent to two golf ball layers that are formed from different materials and do not comprise the non-isocyanate-containing polyurethane composition.

16. The golf ball of claim 11, wherein the non-isocyanate-containing polyurethane composition further comprises density-adjusting fillers, process aides, plasticizers, blowing or foaming agents, fillers such as metal powder, metal alloy powder, metal oxide, metal stearates, particulates, flakes, fibers, carbonaceous material, or combinations thereof.

17. A golf ball comprising at least one layer consisting of a non-isocyanate-containing polyurethane composition comprising the reaction product of at least one amine or polyamine having an average functionality of 2.0 or greater, and at least one cyclo-carbonated soybean oil.

18. The golf ball of claim 17, wherein the at least one layer is a cover layer.

19. The golf ball of claim 17, wherein the at least one layer is a coating layer that is formed about an outermost cover layer of the golf ball.

20. The golf ball of claim 17, wherein the at least one layer is a tie layer that is disposed between and adjacent to two golf ball layers that are formed from different materials and do not comprise the non-isocyanate-containing polyurethane composition.

21. The golf ball of claim 17, wherein the non-isocyanate-containing polyurethane composition further comprises density-adjusting fillers, process aides, plasticizers, blowing or foaming agents, fillers such as metal powder, metal alloy powder, metal oxide, metal stearates, particulates, flakes, fibers, carbonaceous material, or combinations thereof.

22. A golf ball comprising at least one layer consisting of a non-isocyanate-containing polyurethane composition comprising the reaction product of at least one lignin-based polyamine and at least one cyclo-carbonated soybean oil.

23. The golf ball of claim 22, wherein the at least one layer is a cover layer.

24. The golf ball of claim 22, wherein the at least one layer is a coating layer that is formed about an outermost cover layer of the golf ball.

25. The golf ball of claim 22, wherein the at least one layer is a tie layer that is disposed between and adjacent to two golf ball layers that are formed from different materials and do not comprise the non-isocyanate-containing polyurethane composition.

23. The golf ball of claim 22, wherein the non-isocyanate-containing polyurethane composition further comprises density-adjusting fillers, process aides, plasticizers, blowing or foaming agents, fillers such as metal powder, metal alloy powder, metal oxide, metal stearates, particulates, flakes, fibers, carbonaceous material, or combinations thereof.

24. A golf ball comprising:
a first layer consisting of a non-isocyanate-containing polyurethane composition comprising the reaction product of at least one amine or polyamine having an average functionality of 2.0 or greater, and at least one cyclo-carbonate;
wherein the first layer is disposed between and adjacent to a second inner layer and third outer layer, each which do not contain the non-isocyanate-containing polyurethane composition of the first layer;
wherein the first layer has a first coefficient of restitution that is less than a second coefficient of restitution of the second inner layer and less than a third coefficient of restitution of the third outer layer; and
wherein the golf ball as a whole has a ball coefficient of restitution that is greater than the first coefficient of restitution and less than at least one of the second coefficient of restitution and the third coefficient of restitution.

25. A golf ball comprising:
a first layer consisting of a non-isocyanate-containing polyurethane composition comprising the reaction product of at least one amine or polyamine having an average functionality of 2.0 or greater, and at least one cyclo-carbonate;
wherein the first layer is adjacent to a second layer that does not contain the non-isocyanate-containing polyurethane composition of the first layer;
wherein the first layer has a first coefficient of restitution that is less than a second coefficient of restitution of the second layer; and
wherein the golf ball as a whole has a ball coefficient of restitution that is greater than the first coefficient of restitution.
